(19) United States
(12) Patent Application Publication
(10) Pub. No.: US 2007/0013904 A1
(43) Pub. Date: Jan. 18, 2007

(54) Apparatus and system for characterizing a target

(76) Inventors: Chee Wai Chia, Penang (MY); Joh Joh Ng, Perak (MY); Khee Boon Lim, Penang (MY)

Correspondence Address: AVAGO TECHNOLOGIES, LTD., P.O. BOX 1920, DENVER, CO, 80201-1920, US

(21) Appl. No.: 11/182,440

(22) Filed: Jul. 15, 2005

(51) Int. Cl. G01N 21/00

(52) U.S. Cl. 356/238.1

(57) ABSTRACT

In one embodiment, apparatus for characterizing a target is provided with a plurality of light sources that are positioned to illuminate a target. The light sources emit different wavelengths of light. A color sensor is positioned to receive and sense different wavelengths of light reflected from the target. A control system is operably associated with the plurality of light sources and the color sensor to A) in a calibration mode, operate the light sources and separately regulate drive signals of light sources emitting different wavelengths of light, in response to outputs of the color sensor, and B) in an operational mode, i) operate the light sources using the regulated drive signals, and ii) characterize the target in response to data output from the color sensor. A textile characterization system is also disclosed.

### BACKGROUND

Automated optical inspection systems for detecting contaminated textiles are becoming increasingly prevalent in the textile industry. This is because automated optical inspection is typically cheaper, more efficient, and more reliable than human inspection of textiles. However, automated optical inspection systems are not without their limitations. For example, with respect to certain types of contaminants, automated optical inspection systems may not be as sensitive as the human eye. Automated systems may also be subject to drifts in their configuration, which can lead to 1) a failure to properly identify contaminants, or 2) a misidentification of contaminants.

### SUMMARY OF THE INVENTION

In one embodiment, apparatus for characterizing a target comprises a plurality of light sources, a color sensor and a control system. The plurality of light sources is positioned to illuminate a target and emits different wavelengths of light. The color sensor is positioned to receive and sense different wavelengths of light reflected from the target. The control system is operably associated with the plurality of light sources and the color sensor to A) in a calibration mode, operate the light sources and separately regulate drive signals of light sources emitting different wavelengths of light, in response to outputs of the color sensor, and B) in an operational mode, i) operate the light sources using the regulated drive signals, and ii) characterize the target in response to data output from the color sensor.

In another embodiment, a system for characterizing a textile comprises a plurality of light sources, a color sensor, a control system and a feed system. The plurality of light sources is positioned to illuminate the textile and emits different wavelengths of light. The color sensor is positioned to receive and sense different wavelengths of light reflected from the textile. The control system is operably associated with the plurality of light sources and the color sensor to A) in a calibration mode, operate the light sources and separately regulate drive signals of light sources emitting different wavelengths of light, in response to outputs of the color sensor, and B) in an operational mode, i) operate the light sources using the regulated drive signals, and ii) characterize the textile in response to data output from the color sensor. The feed system moves the textile in relation to the color sensor, to thereby cause the color sensor to receive light reflected from different portions of the textile.

Other embodiments are also disclosed.

### BRIEF DESCRIPTION OF THE DRAWINGS

Illustrative and presently preferred embodiments of the invention are illustrated in the drawings, in which:

FIG. 1 illustrates an exemplary method for characterizing a target in response to data obtained from a color sensor;

FIG. 2 illustrates a first exemplary system for characterizing a target in response to data obtained from a color sensor;

FIG. 3 illustrates an exemplary method for, in an operational mode, characterizing a target in response to data obtained from a photodetector and, in a calibration mode, regulating drive signals of a number of light sources; and

FIG. 4 illustrates a second exemplary system for characterizing a target in response to data obtained from a color sensor, which apparatus also provides a calibration mode in which drive signals of a number of light sources are regulated.

### DETAILED DESCRIPTION

Contaminant detection is especially important in the textile industry, where textiles must be continually monitored during manufacture to ensure proper color, quality and density. Contaminant or anomaly detection is also important in other industries, such as the food & beverage industry, liquid processing industries, and others.

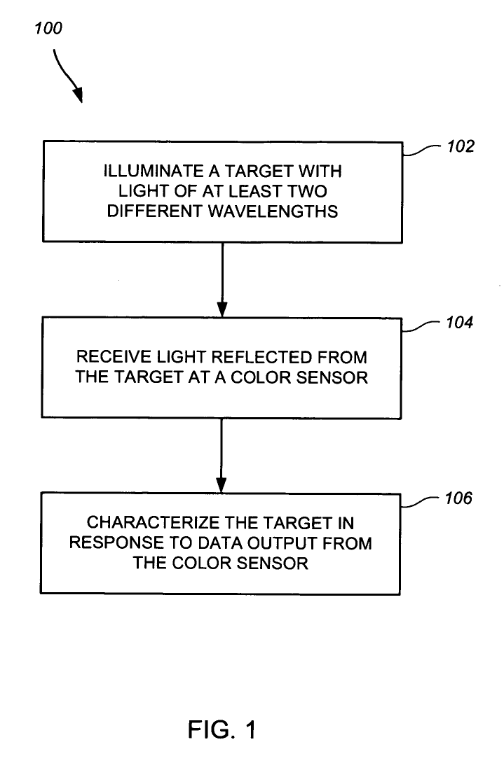

Current automated optical inspection systems for detecting contaminated textiles utilize a single-color light source such as a solid-state light source (e.g., a light emitting diode (LED)), together with a photodiode that converts light reflected from a textile into a photocurrent. This photocurrent can then be used to characterize the textile and determine whether it is contaminated. However, one problem with such a system is that its contamination detection capabilities are limited, as the system can only detect a single light intensity, and different contaminants or textile properties may cause the same intensity of light to be reflected. FIGS. 1 & 2 therefore illustrate a method 100 and system 200 that are capable of detecting a wider range of contaminants and/or textile properties.

Referring to FIG. 1, the method 100 commences with the illumination 102 of a target with light of at least two different wavelengths. Light reflected from the target is then received 104 by a color sensor (which may take the form of a CCD, or one or more filtered photosensors, phototransistors or photodiodes), and data output by the color sensor is used to characterize 106 the target.

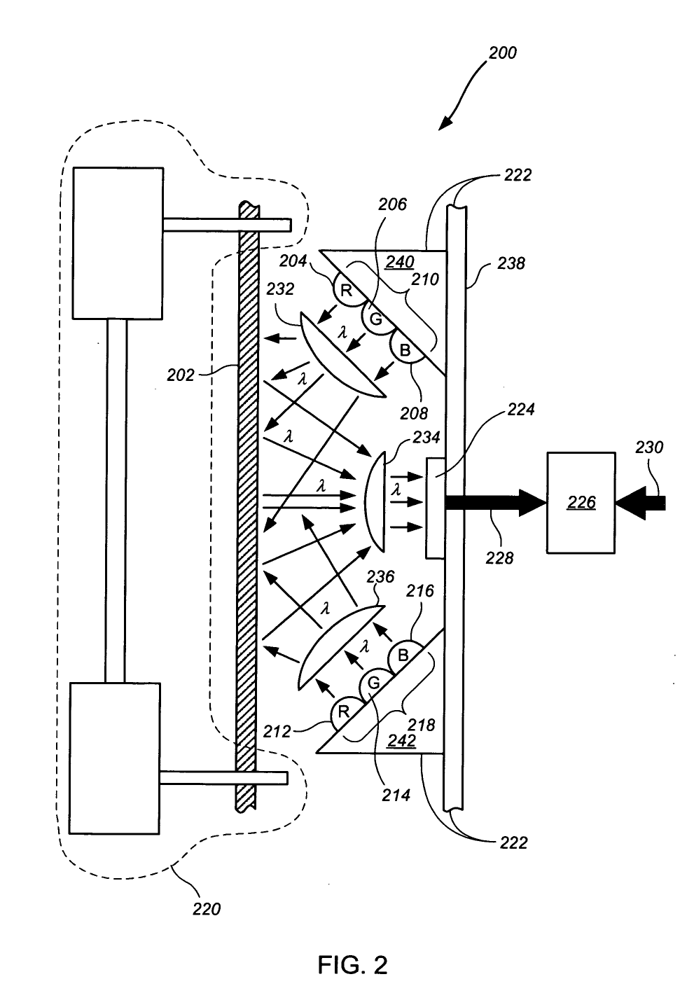

FIG. 2 illustrates an exemplary apparatus 200 for implementing the method 100. The apparatus 200 comprises a number of light sources 204, 206, 208, 212, 214, 216 that are positioned to illuminate a target 202 with at least two different wavelengths of light (λ). In one embodiment, the light sources may comprise solid-state light sources such as LEDs or laser diodes. By way of example, the apparatus 200 is shown to comprise two groups 210, 218 of light sources, each comprising red (R) 204, 212, green (G) 206, 214 and blue (B) 208, 216 LEDs. However, the number, groups and colors of light sources included in the apparatus 200 can vary depending on the application.

The light projected by the light sources 204-208, 212-216 is reflected from the target 202 (e.g., a textile such as a strand of yarn) onto a color sensor 224. Upon receiving the reflected light, the color sensor 224 senses the light and outputs one or more data signals 228 to a control system 226.

In one embodiment, the color sensor 224 may take the form of a charge coupled device (CCD) that senses red, green and blue wavelengths of light. In another embodiment, the color sensor 224 may take the form of a plurality of photodiodes, each of which is filtered so that it only senses a certain wavelength or wavelengths of light. In some cases, the filters may be deposited directly on the photodiodes, or incorporated into encapsulants that protect the photodiodes. In other cases, the filters may be positioned adjacent the photodiodes. In yet another embodiment, the color sensor 224 may take the form of a photodiode having a color wheel positioned between it and the target 202. In this manner, the photodiode could be operated to detect different colors of light sequentially.

As shown in FIG. 2, the light sources 204-208, 212-216 and color sensor 224 may be mounted on a substrate or frame 222 which holds the light sources 204-208, 212-216 and color sensor 224 in fixed relation to one another. Depending upon the type, size and location of a target 202 to be characterized, as well as the number of light sources 204-208, 212-216, the frame 222 may take on a variety of configurations. In one embodiment, it comprises a printed circuit board 238 to which generally triangular bases 240, 242 are mounted for positioning the groups 210, 218 of light sources at a desired angle. Alternately (not shown), the light sources 204-208, 212-216 can take the form of through-hole lamps having leads that can be bent to position them at any desired angle.

In one embodiment, a number of optic elements 232, 234, 236 are included with the apparatus 200. As shown, the optic elements 232-236 may take the form of plano-convex lenses that are 1) positioned between each group 210, 218 of light sources and the target 202 so as to mix emitted light and broadly illuminate the target 202 with mixed light, and 2) positioned between the target 202 and the color sensor 224 so as to collimate the light received by the color sensor 224. Although not shown, the optic elements 232-236 may be mounted to, and suspended over, the frame 222.

Data 228 output from the color sensor 224 is provided to a control system 226 for analysis. In one embodiment, the control system 226 compares the data 228 received from the color sensor 224 (which is indicative of the intensities of different wavelengths of reflected light) to expected light intensity values. Then, based on these comparisons, the control system 226 may variously characterize the target 202 as 1) being within or outside of predetermined tolerances, 2) having or not having a certain kind of contaminant thereon or therein, or 3) being of an incorrect density.

The light intensity values to which the control system 226 compares the data 228 may be fixed or programmable, and may be internally stored by the control system 226, or obtained via an interface 230. Regardless, the control system 226 may provide a signal of any perceived problems with the target 202 to an equipment operator or machine control system.

In one embodiment, the apparatus 200 is incorporated into a system (or alternately controls a system) that comprises a feed system 220 for moving the target 202 in relation to the light sources 204-208, 212-216 and color sensor 224. In this manner, different portions of a target such as a yarn strand may be assessed and characterized. Optionally, the control system 226 may halt the feed system 220 upon detecting a target irregularity.

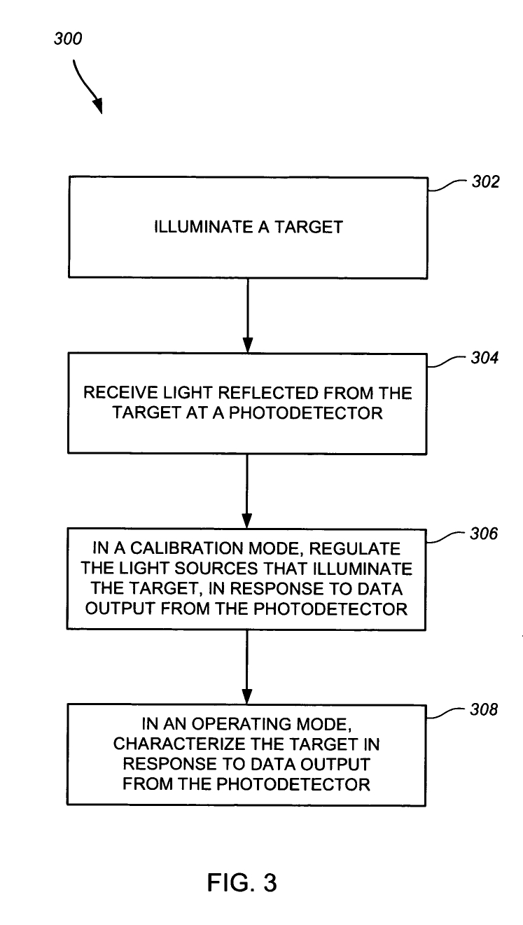

Another problem with conventional automated optical inspection systems (i.e., those comprising a single-color light source and a photodiode) is that the light emitted by a solid-state light source is subject to change as a result of changes in its temperature and aging. The light-emitting characteristics of solid-state light sources can also vary from batch to batch. As a result, in systems where the integrity of light emitted by a light source needs to be maintained (e.g., in textile contamination detection systems), it would be beneficial to provide a means for calibrating the light that is emitted by the system's light source(s). FIGS. 3 & 4 therefore illustrate a method 300 and system 400 that are capable of regulating the light sources of an automated optical inspection system.

Referring to FIG. 3, the method 300 commences with the illumination 302 of a target (possibly with different wavelengths of light). Light reflected from the target is then received 304 by a photodetector (which in some cases may be a color sensor, including one or more photosensors, phototransistors or photodiodes), and data output by the photodetector is provided to a control system. In a calibration mode, the control system regulates 306 the drive signals of the light sources that illuminate the target; and in an operational mode, the control system characterizes 308 the target in response to the data output by the photodetector.

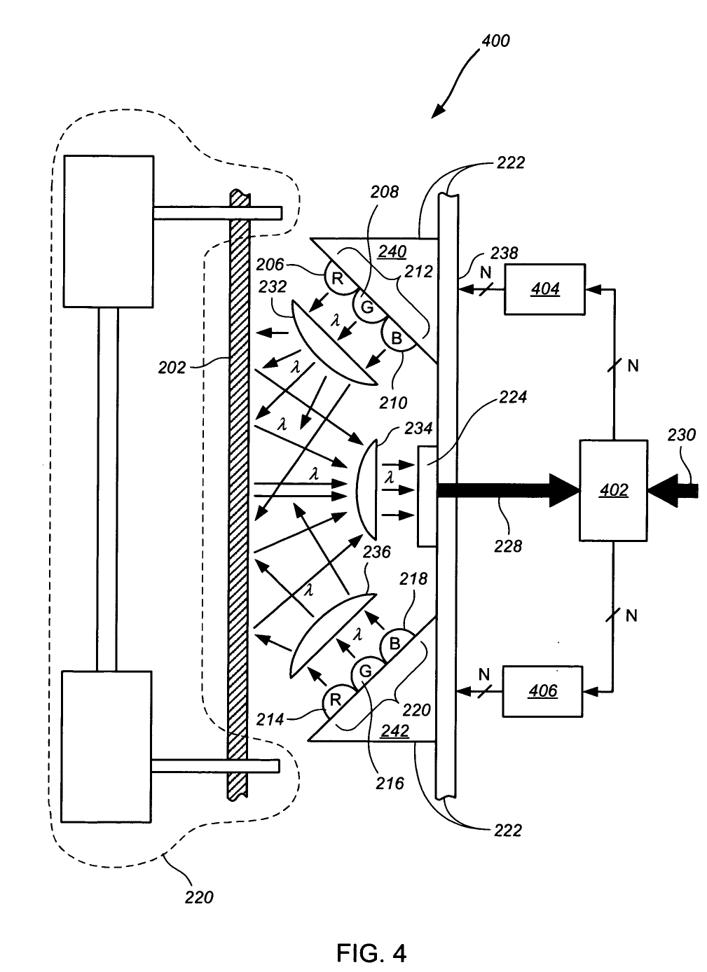

FIG. 4 illustrates an exemplary apparatus 400 for implementing the method 300. In general, the apparatus 400 may be configured similarly to the apparatus 200. Thus, similar elements are provided similar reference numbers in FIGS. 2 & 4. Of note, however, the apparatus 400 need not comprise light sources for emitting different wavelengths of light. That is, the apparatus 400 could be provided with one or more light sources that all emit the same wavelength of light.

Of note in the apparatus 400 is the alternate control system 402, which not only characterizes the target 202, but also regulates the light sources 204-208, 212-216. That is, during an “operational mode”, the control system 402 receives data from the color sensor 224 and characterizes the target 202 as already described with respect to the apparatus 200. However, the control system 402 is also capable of entering a “calibration mode”. In its calibration mode, a target having known characteristics is illuminated by the light sources 204-208, 212-216, and the data 228 received from the color sensor 224 is analyzed by the control system 402 to determine whether it 1) corresponds to defined calibration values, or 2) is within defined calibration ranges. If not, the control system 402 adjusts the drive signals of the light sources 204-208, 212-216 so as to regulate the light emitted thereby. As shown, the control system 402 may provide control signals to separate driver circuits 404, 406. Alternately, the driver circuits may be included within the control system 402. By way of example, the drive signals may be pulse width modulated, and regulation of the drive signals may comprise changing their pulse width modulation.

If the apparatus 400 comprises light sources 204-208, 212-216 of different colors, as well as a color sensor 224, the control system 402 may regulate the drive signals of each differently-colored light source individually, thereby regulating both the intensity and color of light that is emitted by the light sources 204-208, 212-216. However, if the apparatus 400 were alternately provided with only a single light source, or a plurality of light sources of one color, the control system 402 would still be useful, but only to regulate the intensity of the light emitted by the light source(s).

Similarly to the control values used to characterize a target, the desired calibration values used by the control system 402 may be fixed or programmable, and may be internally stored by the control system 402, or obtained via an interface 230.

In one embodiment, the calibration mode is entered upon action by a machine operator. In another embodiment, the calibration may be automatically initiated by a machine (including, for example, the control system 402). In either case, a target having known characteristics should be illuminated during the calibration mode. Referring to FIG. 4, and by way of example, the target having known characteristics may take the form of a “yarn standard”, or a surface of the feed system from which light can be reflected in a known manner (e.g., a reflective calibration target).

Preferably, the calibration mode of the control system 402 is entered before first use of the apparatus 400, and then periodically thereafter.

What is claimed is:

1. Apparatus for characterizing a target, comprising:
a plurality of light sources, positioned to illuminate a target, the light sources emitting different wavelengths of light;
a color sensor, positioned to receive and sense different wavelengths of light reflected from the target; and
a control system, operably associated with the plurality of light sources and the color sensor to A) in a calibration mode, operate the light sources and separately regulate drive signals of light sources emitting different wavelengths of light, in response to outputs of the color sensor, and B) in an operational mode, i) operate the light sources using the regulated drive signals, and ii) characterize the target in response to data output from the color sensor.

2. The apparatus of claim 1, wherein the plurality of light sources are arranged in groups.

3. The apparatus of claim 2, further comprising a number of optic elements, wherein each of the optic elements is positioned between one of the groups of light sources and the target.

4. The apparatus of claim 3, wherein at least one of the optic elements comprises a lens.

5. The apparatus of claim 1, wherein the number of light sources comprises light emitting diodes (LEDs).

6. The apparatus of claim 1, wherein the control system provides pulse width modulated signals to the number of light sources.

7. The apparatus of claim 1, wherein the color sensor is a charge coupled device.

8. The apparatus of claim 1, wherein the color sensor comprises a plurality of color sensors, each sensing a different wavelength of light reflected from the target.

9. The apparatus of claim 8, wherein the color sensor comprises photodetectors that are filtered to sense different wavelengths of light.

10. The apparatus of claim 1, wherein the color sensor comprises a color wheel.

11. The apparatus of claim 1, wherein the control system triggers the calibration mode on a periodic basis.

12. A system for characterizing a textile, comprising:
a plurality of light sources, positioned to illuminate the textile, the light sources emitting different wavelengths of light;
a color sensor, positioned to receive and sense different wavelengths of light reflected from the textile;
a control system, operably associated with the plurality of light sources and the color sensor to A) in a calibration mode, operate the light sources and separately regulate drive signals of light sources emitting different wavelengths of light, in response to outputs of the color sensor, and B) in an operational mode, i) operate the light sources using the regulated drive signals, and ii) characterize the textile in response to data output from the color sensor; and
a feed system to move the textile in relation to the color sensor, to thereby cause the color sensor to receive light reflected from different portions of the textile.

13. The system of claim 12, further comprising a first optics assembly, positioned between the number of light sources and the textile, to direct light onto the textile.

14. The system of claim 13, further comprising a second optics assembly, positioned between the color sensor and the textile, to collimate light reflected from the textile onto the color sensor.

15. The system of claim 12, wherein the feed system is a yarn feed system.
